(19) United States
(12) Patent Application Publication
(10) Pub. No.: US 2025/0126221 A1
(43) Pub. Date: Apr. 17, 2025

(54) METHOD, APPARATUS, ELECTRONIC DEVICE AND READABLE MEDIUM FOR VIDEO RECORDING

(71) Applicant: Beijing Zitiao Network Technology Co., Ltd., Haidian District, Beijing (CN)

(72) Inventor: Wei Peng, Beijing (CN)

(21) Appl. No.: 18/688,742

(22) PCT Filed: Aug. 24, 2022
(86) PCT No.: PCT/CN2022/114379

§ 371 Date: Mar. 1, 2024

(30) Foreign Application Priority Data
Sep. 2, 2021 (CN) 202111027906.9

(51) Int. Cl. H04N 5/272; G06T 15/50; H04N 23/63

(52) U.S. Cl. CPC H04N 5/272; G06T 15/50; H04N 23/631

(57) ABSTRACT

The disclosure provides a method, apparatus, electronic device, and storage medium for video recording. The method for video recording includes: extracting outline information of a first object in a template material, wherein the template material comprises the first object and a background; acquiring a recording material imported by a user based on the outline information, wherein the recording material comprises a second object corresponding to the first object; and adding the second object into a region corresponding to the first object in the template material to acquire a target video, wherein the target video comprises the second object and the background.

### CROSS-REFERENCE TO RELATED APPLICATIONS

The present application is a national stage of the International application PCT/CN2022/114379, filed on Aug. 24, 2022. This International application claims priority to Chinese Patent Application No. 202111027906.9, filed on Sep. 2, 2021. All of these applications are incorporated herein by reference in their entireties.

### FIELD

Example embodiments of the present disclosure generally relate to the technical field of image processing, for example, to a method, apparatus, electronic device, and storage medium for video recording.

### BACKGROUND

With the development of social networking, capturing and special effect processing software, a variety of entertaining and interesting applications have emerged. Users can imitate the figures in classic photos or movie segments by capturing photos or video segments, recreating specific scenes and episodes, and experiencing the fun of acting and interpreting. This application requires that the user's imitation content be synthesized with the original photo or segment, i.e., dueting or cooperative video recording. In other words, the user can record a first video on the basis of a second video, and elements of the two videos will be in a new video at the same time. For example, for movie character replacement, the user can capture a video of him or herself and perform the body movements, expressions, and language of the movie character during the capturing process. Then replace the original character in the movie segment with the user, so that the user feels as if he/she is experiencing the movie, so that the result of capturing will be more vivid and closer to the movie segment.

However, due to the complexity and variety of the user's capturing environment, it is difficult for the user to accurately portray the original character, in addition to the difference in the distance and location of the filming device, as well as the differences in the movements imitated respective time, all of which make it difficult to synthesize the original video with the user's captured content. In video recording applications, the figures or scenes that can be imitated by users are relatively simple, basically involving only facial expressions or a small number of head movements and small-amplitude changes. If the movement range is large, or if it involves changes in body movements, it is not possible to complete a high-quality video recording, resulting in the fragmentation of the user's capturing content from the original material and the transition is not natural, so the compositing effect is poor, which affects the user's user experience.

### SUMMARY

The present disclosure provides a method, apparatus, electronic device, and storage medium for video recording to improve the consistency of recording material with template material and to improve the accuracy of the video recording.

The present disclosure provides a method for video recording, comprising:
extracting outline information of a first object in a template material, wherein the template material comprises the first object and a background;
acquiring a recording material imported by a user based on the outline information, wherein the recording material comprises a second object corresponding to the first object; and
adding the second object into a region corresponding to the first object in the template material to acquire a target video, wherein the target video comprises the second object and the background.

The present disclosure further provides an apparatus for video recording, comprising:
an outline extraction module configured to extract outline information of a first object in a template material, wherein the template material comprises the first object and a background;
a material acquiring module configured to acquire a recording material imported by a user based on the outline information, wherein the recording material comprises a second object corresponding to the first object; and
a video recording module configured to add the second object into a region corresponding to the first object in the template material to acquire a target video, wherein the target video comprises the second object and the background.

The present disclosure further provides an electronic device, comprising:
at least one processor; and
a storage apparatus configured to store at least one program;
wherein the at least one program, when executed by the at least one processor, causes the at least one processor to implement the method for video recording as described above.

The present disclosure further provides a computer-readable storage medium storing a computer program, the computer program, when executed by a processor, causing the method for video recording as described above to be implemented.

### BRIEF DESCRIPTION OF THE DRAWINGS

FIG. 1 shows a flowchart of a method for video recording provided by embodiment 1 of the present disclosure;

FIG. 2 shows a flowchart of a method for video recording provided by embodiment 2 of the present disclosure;

FIG. 3 shows a schematic diagram of a first object in a template material provided by embodiment 2 of the present disclosure;

FIG. 4 shows a schematic diagram of outline information of a first object provided by embodiment 2 of the present disclosure;

FIG. 5 shows a schematic diagram of a background completion on a vacant region with the first object removed provided by embodiment 2 of the present disclosure;

FIG. 6 shows a schematic diagram of a user capturing interface provided by embodiment 2 of the present disclosure;

FIG. 7 shows a schematic diagram of a determination of template material provided by embodiment 2 of the present disclosure;

FIG. 8 shows a flowchart of a method for video recording provided by embodiment 3 of the present disclosure;

FIG. 9 shows a schematic structural diagram of an apparatus of video recording provided by embodiment 4 of the present disclosure;

FIG. 10 shows a hardware schematic structural diagram of an electronic device provided by embodiment 5 of the present disclosure.

### DETAILED DESCRIPTION

Embodiments of the present disclosure will be described below with reference to the accompanying drawings. Although some embodiments of the present disclosure are shown in the accompanying drawings, however, the present disclosure can be implemented in a variety of forms, and these embodiments are provided for the purpose of understanding the present disclosure. The accompanying drawings and embodiments of the present disclosure are intended to be exemplary only.

The plurality of steps documented in the method embodiments of the present disclosure may be performed in a different order, and/or in parallel. In addition, the method embodiments may include additional steps and/or omit performing the illustrated steps. The scope of the present disclosure is not limited in this regard.

As used herein, the term “comprises” and its variations are open-ended, i.e., “comprising, but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions of other terms will be given in the description below.

The concepts of “first”, “second”, etc. mentioned in the present disclosure are used only to distinguish between different apparatuses, modules, or units, and are not intended to limit the order or interdependence of the functions performed by these apparatuses, modules, or units.

The names of messages or information interacting between multiple apparatuses in the embodiments of the present disclosure are for illustrative purposes only and are not intended to limit the scope of such messages or information.

In the following embodiments, optional features and examples are provided in respective embodiment, and a plurality of features described in the embodiments may be combined to form a plurality of options, and respective numbered embodiment should not be regarded as only one technical solution. In addition, the embodiments, and the features in the embodiments in the present disclosure may be combined with respective other without conflict.

### Embodiment 1

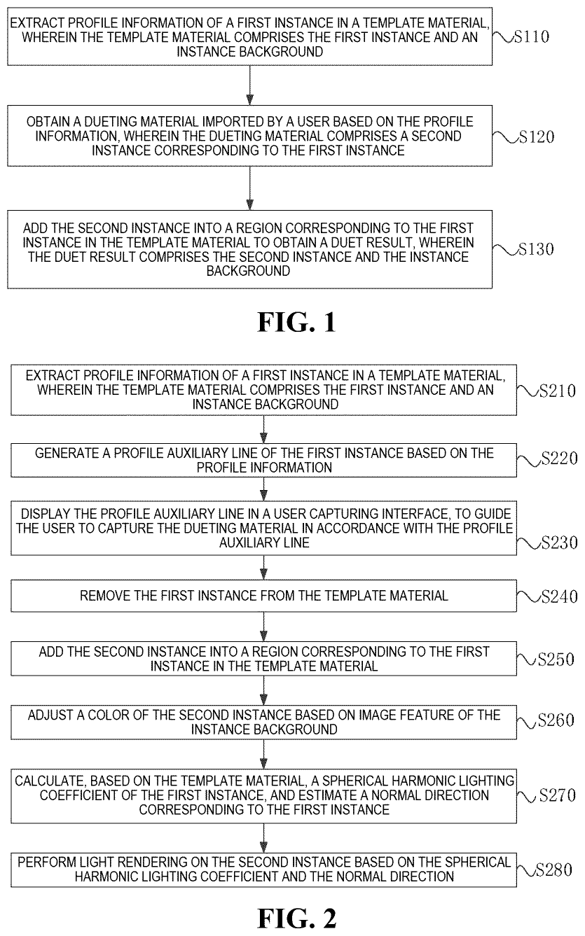

FIG. 1 shows a flowchart of a method for video recording provided by embodiment 1 of the present disclosure. The method may be applicable to a situation where a user performs video recording in accordance with a template material, wherein imitation or deduction of a plurality of scenes or episodes is implemented by adding objects from the recording material to the template material and synthesizing them with the background of objects in the template material. The method may be performed by a video recording apparatus, wherein the apparatus may be implemented by software and/or hardware and integrated on an electronic device. The electronic device in the present embodiment may be a device with image processing capabilities such as a computer, a laptop, a server, a tablet, or a smartphone.

As shown in FIG. 1, embodiment 1 of the present disclosure provides a method for video recording, comprising:

S110. Extract outline information of a first object in a template material, wherein the template material comprises the first object and a background.

In the present embodiment, the template material may be an image or video for reference by the user for imitation or deduction. This may be, for example, a famous painting, a classic movie segment, or a special effects animation. The template material for the video recording may be specified by the user and may be downloaded locally by the electronic device from a library of materials. The template material comprises a first object and a background. Herein, the first object comprises an object to be imitated or interpreted by the user, which will not be displayed in the target video but will be replaced or overwritten by the content imitated or interpreted by the user. For example, the first object may be a character in a movie segment, or may comprise a hand-held prop, etc.; the background of the object comprises objects that do not need to be imitated or interpreted by the user, and may be displayed in the target video, such as the environment around the figures in the movie segment, such as walls, roads, rivers, etc.

There can be a plurality of objects in the template material, and the semantic partitioning algorithm or object partitioning algorithm can recognize all objects in the template material and segment them. The principle can be as follows: for respective object in the template material, the bounding box is detected and localized, and for the bounding box where the respective object is located, the interior of the bounding box is partitioned by front and back view at pixel level, i.e., the front view is the object, and the back view can be regarded as the background of the object. The first object may be one or more of a plurality of objects. The first object may be determined by the electronic device based on a default configuration of the template material or may be specified by the user. The semantic partitioning algorithm is mainly applicable to the case where there is one first object in the template material, and the object partitioning algorithm is mainly applicable to the case where there are at least two first objects in the template material.

The outline information of the first object can be extracted by semantic partitioning or object partitioning algorithms. The outline information is used to describe the position and shape of the first object. For example, if the first object in the template material is a little girl dancing, the outline information needs to indicate the position of the little girl in the template material and the dancing posture, so as to assist the user in adjusting the capturing angle when using the electronic device for capturing, and to guide the user to correctly occupy the position in the captured picture. The outline information can be provided by forms of characters, lines, symbols, sketches, or auxiliary lines, etc.

In one embodiment, after determining the first object of the template material, the outline information of the first object is stored locally, and when the user is capturing the recording material, the outline information is read and visualized in the user capturing interface to guide the user to occupy the position and complete the corresponding action. Herein, since the template material has been downloaded to the local electronic device, the process of semantic partitioning or object partitioning of the template material can be performed offline.

S120. Acquire a recording material imported by a user based on the outline information, wherein the recording material comprises a second object corresponding to the first object.

Recording materials can be images or videos captured by users to imitate or deduce the first object, wherein the content imitated or deduced by the user is the second object, and the second object corresponds to the first object, for example, it can be reflected in the same or similar outlines of the second object and the first object. Recording materials can be materials captured by users in real time based on the outline information of the first object or capturing completed materials imported from the image gallery. The capturing completed materials comprise objects with the same or similar outlines as the first object. Based on this, the consistency of the outlines of the second object and the first object can be ensured, the usability of recording materials can be improved, and it is also convenient to accurately synthesize the background of the second object and the object.

In one embodiment, the recording material may further comprise a capturing background, i.e., the environment in which the user captures the recording material. For example, the user imitates the little girl dancing in the template material in the bedroom and performs a capturing, the capturing pictures can be used as recording material. The user dancing in the capturing picture is the second object, and the bedroom environment in the capturing picture is the capturing background.

In the present embodiment, semantic partitioning or object partitioning is required for the recording material imported by the user to acquire the second object and the capturing background, wherein the second object is used to replace or overwrite the first object in the template material, so as to synthesize with the background to implement video recording. If there is only one second object in the recording material (usually the user himself), the outline of the second object can be extracted using the semantic partitioning algorithm, which can save computation; there may also be multiple second objects in the recording material, and the object partitioning algorithm can be used to recognize all the second objects in the recording material. In this case, the partitioning result of respective second object can be associated with the object identifier. Based on the relative position relationship between a plurality of second objects and/or the outline information of respective second object, the first object associated with respective second object in the template material can be determined, and a plurality of user video recording can be implemented on this basis.

In one embodiment, since the user capturing recording material style is variable and strongly uncertain, semantic partitioning or object partitioning on recording material can be performed online, to facilitate flexible calls related algorithms and the use of computing resources.

S130. Add the second object into a region corresponding to the first object in the template material to acquire a target video, wherein the target video comprises the second object and the background.

The second object can be used to replace or overwrite the first object in the template material, so as to synthesize it with the background to acquire a video recording result. Adding the second object into the region corresponding to the first object can refer to removing the first object from the template material (the region with the first object removed can be in a vacant state or be a blank, or be filled based on the texture characteristics of the background), and then displaying the second object on the region corresponding to the first object, in which case the fusion degree between the second object and the background is higher; it can also refer to using the second object to overwrite the first object, in which case the higher consistency of the outlines of the first object and the second object is required, and it is necessary to ensure that the second object can completely overwrite the first object. Adding the second object into the region corresponding to the first object can also be the synthesis process of the second object and the background.

In one embodiment, the process of adding the second object into the template material can be performed online.

In one embodiment, the region corresponding to the first object includes the outline of the first object. In this case, the region corresponding to the first object is larger than that of the first object. When replacing or overwriting the first object with the second object, the second object is added into a larger region, which can avoid the lack of connection between the second object and the background. The second object exists more naturally on the background, so that the edge transition after replacement is more natural and improves the visual effect of the user on the video recording result.

In one embodiment, if there are a plurality of recording material of the second object, based on the relative position relationship between the plurality of second objects, and/or the outline information of respective second object, it can be determined to which first object of the template material respective second object corresponds, and respective second object can be added into the correspondent area of the corresponding first object of the template material accordingly, to implement the plurality of users video recording.

The present embodiment provides a method for video recording, guiding the user into recording material with the outline information of the first object, to improve the consistency of recording material and template material object outline, so as to implement the synthesis of the second object and the template material background and improve the accuracy of video recording; and due to the guidance of the outline information, the method can be applied to more diverse video recording scenes, even in cases where the first object is complex, the movement is large, or the body movement changes, it is possible to improve the availability of recording material, to ensure the quality of the synthesis effect and video recording.

### Embodiment 2

FIG. 2 shows a flowchart of a method for video recording provided by embodiment 2 of the present disclosure. On the basis of the above embodiment, embodiment 2 illustrate the process of acquiring recording material and adding a second object into the template material.

As shown in FIG. 2, embodiment 2 of the present disclosure provides a method for video recording, comprising:

S210. Extract outline information of a first object in a template material, wherein the template material comprises the first object and a background.

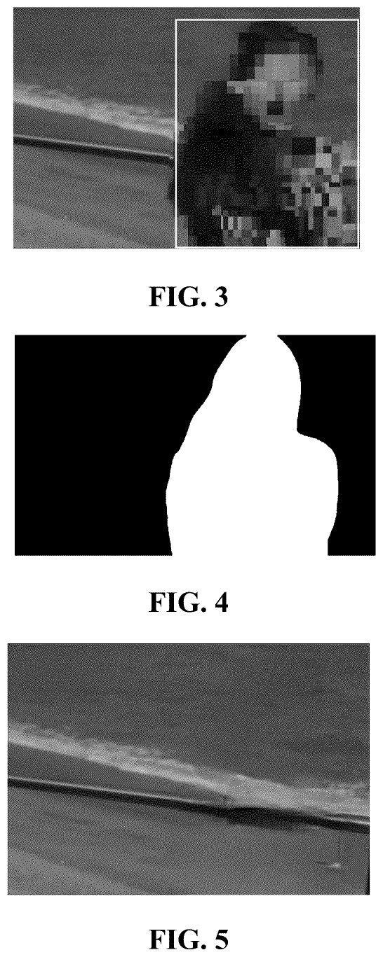

FIG. 3 shows a schematic diagram of a first object in a template material provided by embodiment 2 of the present disclosure. The template material can be an image or a video. If the template material is a video, the outline information of the first object needs to be extracted frame by frame. As shown in FIG. 3, taking an image in the template material as an example, the region circled by a white box includes the first object, which is a figure comprising a head and upper body; the background of the example mainly comprises sea and railings.

FIG. 4 shows a schematic diagram of outline information of a first object provided by embodiment 2 of the present disclosure. As shown in FIG. 4, the first object and the background are acquired by performing object partitioning on the template material. Herein, the black region is the region corresponding to the background in the template material, the white region is the region corresponding to the first object, and the boundary between the black and white regions is the outline of the first object. The outline information can be provided by forms of characters, lines, symbols, sketches, or auxiliary lines, etc.

S220. Generate an outline auxiliary line of the first object based on the outline information.

The outline auxiliary line is used to recognize the position and shape of the first object in the template material. The outline auxiliary line is a line drawn around the outer edge of the first object, which can be represented by a dashed line or solid line. For example, for the first object in FIG. 4, the process of generating the outline auxiliary line can be: based on the object partitioning result, sample the points on the intersection line of the black and white regions in FIG. 4, and start from one sampling point and connect all sampling points in a clockwise or counterclockwise direction to acquire an outline auxiliary line.

S230. Display the outline auxiliary line in a user capturing interface, to guide the user to capture the recording material in accordance with the outline auxiliary line.

In the present embodiment, the recording material is acquired by the user in accordance with the outline auxiliary line. The outline auxiliary line is displayed at a specific position of the capturing picture in the user capturing interface. The position is theoretically consistent with the position of the first object in the template material and allows for errors within a set range. For example, if the first object in FIG. 3 is located in the middle-right region of the template material, then in the user capturing interface, the outline auxiliary line is also located in the middle-right region of the capturing picture. On this basis, the outline auxiliary line can guide the user to adjust the capturing angle, causing the second object captured (such as the user himself) to locate in the outline auxiliary line, so that the electronic device can quickly extract the second object from the middle-right region of the capturing picture for video recording. The user capturing interface can further display prompt information such as characters, lines, symbols, and/or sketches, and the user can start deducing and capturing based on this prompt information and the outline auxiliary line.

In one embodiment, in the user capturing interface, in accordance with a determination that an error between an outline of the second object and the outline auxiliary line is within a setting range, determining a captured image as the recording material.

In the user capturing interface, an error between an outline of the second object and the outline auxiliary line is within a setting range, i.e., the position and shape of the second object are consistent or close to the outline (or outline auxiliary line) of the first object, indicating that the capturing picture of the user can correspond to the template material and have the synthesis condition. In this case, the captured picture can be used as the recording material; if the position and shape of the second object are inconsistent or too far away from the outline (or outline auxiliary line) of the first object, the capturing picture cannot accurately correspond to the template material, and the background of the second object cannot be accurately linked up or synthesized, then the user can be guided to adjust the position and shape by a prompt message. The error between the outline and the outline auxiliary line of the second object is within the set range, which can refer to the number of pixels outside the outline auxiliary line in the second object being lower than the first threshold, the degree of overlapping between the outline and the outline auxiliary line of the second object being higher than the second threshold, and the farthest distance between the outline and the outline auxiliary line of the second object being smaller than the third threshold

In one embodiment, after acquiring a recording material imported by a user based on the outline information, further comprises: performing semantic partitioning or object partitioning on the recording material to acquire the second object.

The present embodiment takes the recording material as the capturing picture in the user capturing interface as an example and extract the second object from the capturing picture with the semantic partitioning or object partitioning algorithms, and the second object may be one or more. If there is only one second object in the recording material, the outline of the second object can be extracted with the semantic partitioning algorithm, and it can be added into the region corresponding to the first object in the template material on this basis; if there are a plurality of second objects in the recording material, all the second objects in the recording material can be recognized with the object partitioning algorithm. In this case, respective second object can be used to replace or overwrite the first object associated with the template material, and the plurality of users video recording can be implemented on this basis.

S240. Remove the first object from the template material.

In the present embodiment, the first object is removed from the template material, and the first object can be cut out by a cutout algorithm. The region with the first object removed can be in a vacant state or be a blank and can further be filled based on the texture characteristics of the background.

In one embodiment, after the first object is removed, further comprise: performing, based on an image feature of the background, a background completion on a vacant region with the first object removed.

FIG. 5 shows a schematic diagram of a background completion on a vacant region with the first object removed provided by embodiment 2 of the present disclosure. The process of background completion can be performed by an image restoration or completion algorithm that using the graphical features of the background to predict the features of the pixel points in the vacant region and fill the vacant region accordingly. As shown in FIG. 5, the background mainly comprises the features of sea and railings. Based on this, the texture of sea and railings is filled in the vacant region after the first object is removed, and the filling content of the vacant region is basically aligned with the background, thereby improving the synthesis quality, and ensuring the visual coherence and consistency of the background. On this basis, after adding the second object into the corresponding region of the first object, the transition between the second object and the background is more natural, and the synthesis effect is better.

S250. Add the second object into a region corresponding to the first object in the template material.

S260. Adjust a color of the second object based on image feature of the background.

Recording materials are captured by users, while template materials are usually captured by professionals or personnel familiar with video making. The capturing conditions, colors, and styles of the materials between the recording materials and the template materials usually differ, resulting in the second object being more abrupt and the transition unnatural compared to the background. In the present embodiment, in order to improve the composite effect of the second object and the background, the color of the second object is adjusted based on the image characteristics of the background, to cause the composite material more harmonious and natural visually. For recording materials, the second object is compared with the background of the corresponding frame in the template material frame by frame, and the color of the second object is adjusted, for example, the color value of respective pixel in the second object can be adjusted.

In the present embodiment, the color of the second object is adjusted based on the image characteristics of the background, and the color of the background in the template material can also be migrated to the second object. In the color migration process, the hue, filters, and/or special effects of the second object can also be adjusted based on the image characteristics of the background, to cause the fusion of the second object and the background more natural. In one embodiment, the process of color migration can be performed online.

S270. Calculate, based on the template material, a spherical harmonic lighting coefficient of the first object, and estimate a normal direction corresponding to the first object.

In the present embodiment, in order to cause the composite result closer and more realistic to the template material, perform a light rendering on the second object with the spherical harmonic lighting model. The process may be migrated to the template material ambient light to the second object, in order to enhance recording material realism and three-dimensionality of the second object.

By sampling the ambient light around the first object in the template material to a plurality of spherical harmonic lighting coefficients of different orientations, it is used to restore the ambient light around it during light rendering of the second object, thereby simplifying the computing process of the ambient light modeling. In one embodiment, the spherical harmonic lighting modeling process can be performed offline.

S280. Perform light rendering on the second object based on the spherical harmonic lighting coefficient and the normal direction.

In the present embodiment, by modeling the ambient light in the template material, a spherical harmonic lighting coefficient for describing the ambient light is acquired, and the normal direction corresponding to the first object is estimated based on the image of the template material and the partitioning acquired. Based on the spherical harmonic lighting coefficient and the normal direction, the light intensity distribution or depth in the normal direction of the first object can be analyzed, and light rendering is performed on the second object accordingly, and the second object in the video recording result is supplemented with light from different orientations. In one embodiment, the process of light rendering on the second object can be performed online.

On the basis of the above, based on the synthesis result of the second object and the background after color migration and light migration, the final video recording result can be output.

The present embodiment is not limited to the performing order of S250-S270. For example, in some scenes, the color migration and/or light migration may be first performed on the second object, and then the second object with the color migration and/or light migration performed on is added to the template material and synthesized it with the background of the object to acquire the video recording result.

In one embodiment, the content displayed by the user capturing interface further comprises a second object and a capturing background, i.e., displaying the capturing picture when the user is imitating or deducing in a real capturing environment in the user capturing interface. The second object is displayed on the real capturing background. On the background, the user can adjust the position based on the outline auxiliary line and complete the corresponding action. In this case, the synthesis of the second object and the background can be performed after the capturing of the recording material is completed, which can reduce the computing amount of the electronic device and the Central Processor (Central Unit Processing, CPU) occupancy rate, and the performance requirements of the electronic device are relatively low.

Alternatively, the content displayed in the user capturing interface further comprises the second object and the background, i.e., during the process of the user capturing the recording material, the user capturing interface displays the composite picture of the second object and the background in the template material in real time. In this case, the user can preview the synthesized effect in real time, which is convenient for the user to adjust the capturing position and action flexibly. In this case, the synthesis of the second object and the background is synchronized with the capturing, which requires a high amount of computing amount and relatively high-performance requirements for the electronic device.

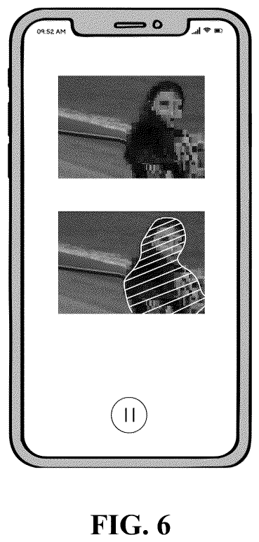

In one embodiment, the user capturing interface can also display template materials, i.e., in addition to displaying the above-mentioned capturing picture or composite picture, the template materials can further be synchronized to facilitate user comparison. FIG. 6 shows a schematic diagram of a user capturing interface provided by embodiment 2 of the present disclosure. As shown in FIG. 6, in the user capturing interface, the upper half displays the template material, and the content displayed in the lower half comprises the outline auxiliary line, and further comprises the composite picture of the second object and the background displayed in real time. The user can adjust its occupancy based on the outline auxiliary line, so that it is located in the outline auxiliary line (the white diagonal line filling region in FIG. 6) and complete the corresponding action.

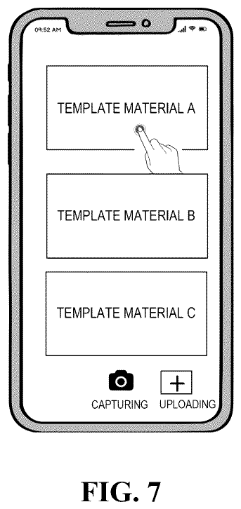

In one embodiment, the material library has a plurality of templates available for video recording, and the template material can select by the user by the template selection interface. FIG. 7 shows a schematic diagram of a determination of template material provided by embodiment 2 of the present disclosure. As shown in FIG. 7, the material library provides a plurality of template material, which are different movie segments, the user can select a template material by the template selection interface and enter the user capturing interface to complete capturing of the recording material.

In one embodiment, further comprises: before extracting outline information of a first object in a template material, recognizing an object that support video recording in the template material; and determining, based on user selection information, at least one first object from the recognized objects that supports video recording.

The template material can have a plurality of objects that supports video recording, and the first object can be one or more of them. Users can select the first object by the object selection interface. For example, the template material is a movie segment with two figures in total. Users can select only one character for deduction and display the character identification of respective character in the object selection interface. For example, respective character is framed with a flashing frame. If the user clicks on one character, the flashing frames of other figures disappear, and the flashing frames of the selected character become always on. The selected character is the first object. Users can also select two figures as the first object. In this case, two users need to deduce together, and respective user deduces one of the characters.

Taking a first object as an example, the process of implementing video recording for the electronic device is briefly illustrated below.
1) determine the template material selected by the user by the template selection interface, such as selecting a movie to be deduced; 2) extract the outline information of the movie character (i.e., the first object) by the object partitioning algorithm, and remove the movie figures in the template material; 3) perform a completion on the vacant region after figure removed based on the image features of the background in the template material by the image repairing algorithm; 4) enter the user capturing interface, and display the outline auxiliary line, generated based on the outline information in the user capturing interface, for guiding the user to occupy the space and complete the corresponding action and determining the capturing picture as the recording material; 5) extract the second object in the recording material by the object partitioning algorithm; 6) perform color migration and/or light migration on the second object based on the background in the template material; 7) synthesize the second object that has undergone color migration and/or light migration with the background in the template material, and output the complete deduction fragment, i.e., the video recording result.

The present embodiment provides a method for video recording, by removing the first object, guiding the user to occupy and complete the corresponding action, color migration and light migration of the second object with the outline auxiliary line, to implement high-quality synthesis of the second object and the background. Herein, the user acquires the recording material based on the guidance of the outline auxiliary line, and can flexibly adjust the capturing angle and action to ensure the high consistency of the recording material and the template material, thereby improving the accuracy and efficiency of synthesis; by performing background completion on the vacant region after the first object is removed based on the image characteristics of the background, ensuring the visual coherence and consistency of the background, and thereby improving the quality of synthesis; by adjusting the color of the second object based on the image characteristics of the background, the transition between the second object and the background is more natural; by using the spherical harmonic lighting model to perform light rendering on the second object, enhancing the realism and three-dimensionality of the recording material of the second object; by flexibly displaying the capturing picture or composite picture in the user capturing interface, the user can previewing the synthesized effect in real time and adjusting the capturing position and action flexibly, which may satisfied the performance requirement of the electronic device.

### Embodiment 3

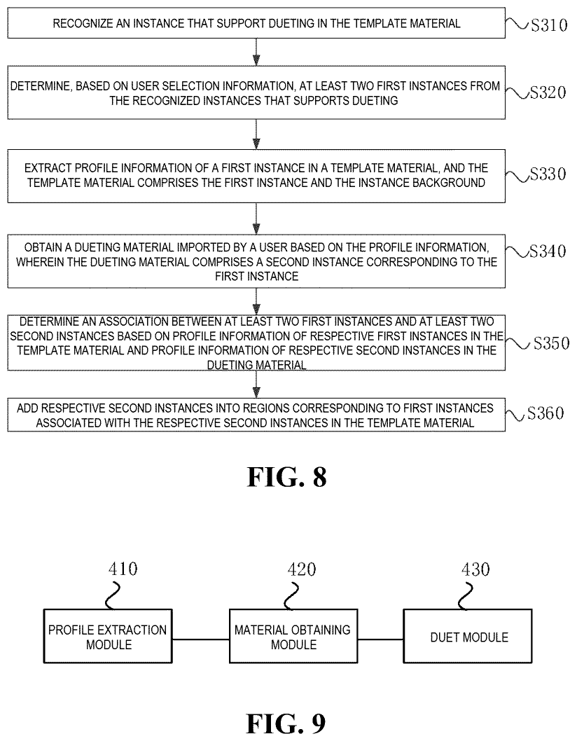

FIG. 8 shows a flowchart of a method for video recording provided by embodiment 3 of the present disclosure. Based on the above embodiment, embodiment 3 illustrates the case where a plurality of first objects and a plurality of second objects existing.

In the present embodiment, the number of the first object is the same as the number of the second object and comprises at least two. The partitioning result of respective first object can be associated with the object identifier, and the partitioning result of respective second object can also be associated with the object identifier. The first object and the second object with the same object identifier are interrelated. Based on the object identifier, the relative position relationship between the objects, and/or the outline information of the objects, the first object associated with respective second object in the template material can be determined, and a plurality of users video recording can be implemented on this basis.

As shown in FIG. 8, embodiment 3 of the present disclosure provides a method for video recording, comprising:

S310. Recognize an object that support video recording in the template material.

S320. Determine, based on user selection information, at least two first objects from the recognized objects that supports video recording.

S330. Extract outline information of a first object in a template material, and the template material comprises the first object and the background.

The outline information of respective first object in the template material is extracted here, and the part outside at least two first objects in the template material is the background.

S340. Acquire a recording material imported by a user based on the outline information, wherein the recording material comprises a second object corresponding to the first object.

In one embodiment, after acquiring a recording material imported by a user based on the outline information, by performing object partitioning on the recording material, at least two second objects can be acquired.

The recording material is jointly deduced by a plurality of people, and there are at least two second objects, at least two of which correspond one-to-one with at least two first objects.

S350. Determine an association between at least two first objects and at least two second objects based on outline information of respective first objects in the template material and outline information of respective second objects in the recording material.

The outline information of respective first object in the template material can be acquired by the object partitioning algorithm, and the outline information of respective second object in the recording material can also be acquired. The plurality of second objects correspond one-to-one with the plurality of first objects. By comparing the outline information of respective first object with respective second object, it is possible to determine which first object respective second object is deduced, thereby determining the correlation between the first object and the second object. For example, if there are two figures in the template material, figure A is in a standing state, and figure B is sitting in a chair, then the correlation refers to: the standing user captured in the recording material deduces figure A, and the sitting user deduces figure B.

In one embodiment, based on the position relationship between at least two second objects, respective second object is determined that which is deduced first object, to determine the association between the first object and the second object. For example, there are two figures in the template material, figure A is on the left and figure B is on the right. The association refers to: the user on the left captured in the recording material deduces figure A, and the user on the right deduces figure B.

S360. Add respective second objects into regions corresponding to first objects associated with the respective second objects in the template material.

In one embodiment, before respective second objects into regions corresponding to first objects associated with the respective second objects, further comprises: removing respective of the first object from the template material; preforming background completion on the vacant region with the respective of first objects removed.

In one embodiment, after respective second objects into regions corresponding to first objects associated with the respective second objects, further comprises: performing color migration and/or light migration for respective second objects of the video recording result.

In one embodiment, the recording material can be captured by a plurality of people at the same time, or it can be captured by one or more users in stages. For example, two people deduce template materials at the same time, one person deduces figure A, and one person deduces figure B. Only one recording material can be captured, and two second objects can be added into the template material respectively. The first person can also deduce figure A first, and the first recording material can be acquired. After the first recording material is completed, the second person deduces figure B, and the second recording material is acquired. In this case, respective recording material comprises a second object, and the second object corresponds to a first object in the template material. In the case of capturing in stages, one user can also capture in stages and play a plurality of roles to enhance the flexibility and interest of video recording.

The present embodiment provides a method for video recording, based on the association between the second object and the first object, a plurality of second objects may be added into the template material, respectively, to implement a plurality of user video recording, improve the flexibility and interest of video recording, and satisfy a variety of video recording requirements. On this basis, the user can experience a real movie atmosphere, can also play with other objects on the same stage, dialogue across time and space, and increase the diversity and playability of video recording applications.

### Embodiment IV

FIG. 9 shows a schematic structural diagram of an apparatus for video recording provided by embodiment 4 of the present disclosure. The present embodiment is not detailed, please refer to the above embodiments.

As shown in FIG. 9, the apparatus comprises: an outline extraction module 410 configured to extract outline information of a first object in a template material, wherein the template material comprises the first object and a background; a material acquiring module 420 configured to acquire a recording material imported by a user based on the outline information, wherein the recording material comprises a second object corresponding to the first object; and a video recording module 430 configured to add the second object into a region corresponding to the first object in the template material to acquire a target video, wherein the target video comprises the second object and the background.

The apparatus for video recording of the present embodiment guides the user to import the recording material with the outline information of the first object to improve the consistency of the recording material and the template material in the object outline, thereby implementing the synthesis of the second object and the template material background and improving the accuracy of video recording.

Based on the above, the material acquiring module 420 comprises:
an auxiliary line generating unit configured to generate an outline auxiliary line of the first object based on the outline information; an auxiliary line display unit configured to display the outline auxiliary line in a user capturing interface, to guide the user to capture the recording material in accordance with the outline auxiliary line.

Based on the above, the material acquiring module 420 further comprises:
a material determination unit configured to, in the user capturing interface, in accordance with a determination that an error between an outline of the second object and the outline auxiliary line is within a setting range, determine a captured image as the recording material.

Based on the above, the video recording module 430 is configured to:
remove the first object from the template material and add the second object into the region corresponding to the first object in the template material.

On the basis of the above, the apparatus further comprises:
a background completion module configured to perform, based on an image feature of the background, a background completion on a vacant region with the first object removed.

On the basis of the above, the apparatus further comprises:
a partitioning module configured to, after acquiring a recording material imported by a user based on the outline information, perform semantic partitioning or object partitioning on the recording material to acquire the second object.

On the basis of the above, the apparatus further comprises:
a color adjustment unit configured to adjust a color of the second object based on image feature of the background.

On the basis of the above, the apparatus further comprises: a light rendering module configured to:
calculate, based on the template material, a spherical harmonic lighting coefficient of the first object, and estimating a normal direction corresponding to the first object; and perform light rendering on the second object based on the spherical harmonic lighting coefficient and the normal direction.

On the basis of the above, the content displayed by the user capturing interface further comprises the second object and a capturing background; or the content displayed by the user capturing interface further comprises the second object and the background.

On the basis of the above, the apparatus further comprises:
an object recognition module configured to, before extracting outline information of a first object in a template material, recognize an object that support video recording in the template material; an object determination module configured to determine, based on user selection information, at least one first object from the recognized objects that supports video recording.

On the basis of the above, the number of the first objects is the same as the number of the second objects, and the number is at least two; and the video recording module 430 comprises: an association determination module configured to determine an association between at least two first objects and at least two second objects based on outline information of respective first objects in the template material and outline information of respective second objects in the recording material; and an object adding module configured to add respective second objects into regions corresponding to first objects associated with the respective second objects in the template material.

Above-described apparatus may perform the present disclosure method for video recording provided in any embodiment, the method of performing processes corresponding functional modules and effects.

### Embodiment V

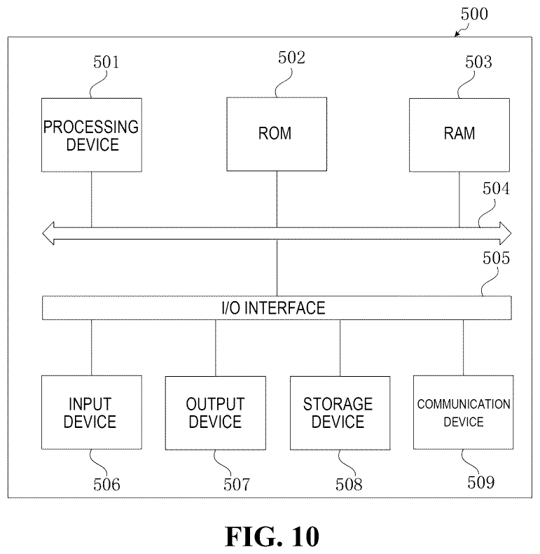

FIG. 10 shows a hardware schematic structural diagram of an electronic device provided by embodiment 5 of the present disclosure. FIG. 10 shows a structural schematic diagram of an electronic device 500 suitable for implementing the embodiments of the present disclosure. The electronic device 500 in the embodiments of the present disclosure comprises but is not limited to devices with image processing functions such as computers, laptops, servers, tablets, or smartphones. The electronic device 500 shown in FIG. 10 is only an example and should not bring any limitations on the functionality and scope of use of the embodiments of the present disclosure.

As shown in FIG. 10, the electronic device 500 may comprise one or more processing devices (such as a central processing unit, a graphic processing unit, etc.) 501, which can perform various appropriate actions and processing based on programs stored in Read-Only Memory (ROM) 502 or loaded from storage device 508 into Random Access Memory (RAM) 503. One or more processing devices 501 implement the traffic data packet forwarding method provided in this disclosure. In RAM 503, various programs and data required for the operation of the electronic device 500 are also stored. The processing devices 501, ROM 502, and RAM 503 are connected to respective other by a bus 504. The input/output (I/O) interface 505 is also connected to the bus 504.

Generally, the following devices can be connected to I/O interface 505: an input device 506 comprising, for example, a touch screen, a touch pad, a keyboard, a mouse, a video camera, a microphone, an accelerometer, a gyroscope, and the like; an output device 507 comprising, for example, a liquid crystal display (LCD), a speaker, a vibrator, and the like; a storage device 508 comprising, for example, a magnetic tape, a hard disk, and the like; and a communication device 509. The communication device 509 may allow the electronic device 500 to communicate wirelessly or wiredly with other devices to exchange data. Although FIG. 10 shows an electronic device 500 with various devices, it should be understood that it is not required to implement or have all of the illustrated devices. More or fewer devices may alternatively be implemented or possessed.

According to embodiments of the present disclosure, the process described with reference to the flowchart above may be implemented as a computer software program. For example, embodiments of the present disclosure comprise a computer program product comprising a computer program hosted on a non-transitory computer-readable medium, the computer program comprising program code for executing the method shown in the flowchart. In such embodiments, the computer program may be downloaded and installed from a network via the communication device 509, or from the storage device 508, or from the ROM 502. When the computer program is executed by the processing device 501, the above functions defined in the method of the embodiments of the present disclosure are performed.

The computer-readable medium described above in the present disclosure may be a computer-readable signal medium or a computer-readable storage medium or any combination thereof. The computer-readable storage medium may, for example, be a system, device, or apparatus or device of electricity, magnetism, light, electromagnetism, infrared, or semiconductors, or an electrical connection of any one or more wires, or a combination of the above. The computer-readable storage medium may comprise: portable computer disk, hard disk, random access memory (RAM), read-only memory (ROM), erasable programmable read-only memory (Erasable Programmable Read-Only Memory, EPROM, or flash memory), optical fiber, portable compact disk read-only memory (Compact Disc Read-Only Memory, CD-ROM, optical storage device, magnetic storage device, or any suitable combination of the foregoing. For purposes of the present disclosure, a computer-readable storage medium may be any tangible medium that contains or stores a program that may be used by or in combination with an instruction execution system, apparatus, or component. And in the present disclosure, a computer-readable signal medium may comprise a data signal propagated in a baseband or as part of a carrier carrying computer-readable program code. Such propagated data signals may take a variety of forms, comprising electromagnetic signals, optical signals, or any suitable combination of the foregoing. The computer-readable signal medium may also be any computer-readable medium other than a computer-readable storage medium that sends, disseminates, or transmits a program for use by, or in conjunction with, an instruction-executing system, apparatus, or component. The program code contained on the computer-readable medium may be transmitted using any suitable medium, comprising: wire, fiber optic cable, radio frequency (RF), etc., or any suitable combination thereof.

In some implementations, clients, servers may communicate with any currently known or future developed network protocol such as HyperText Transfer Protocol (HTTP) and may be interconnected with any form or medium of digital data communication (e.g., a communications network). Examples of communication networks comprise Local Area Networks (LAN), Wide Area Networks (WAN), Internet (e.g., the Internet), and End-to-End Networks (e.g., ad hoc End-to-End Networks), as well as any currently known or future developed networks.

The computer-readable medium may be included in the above-mentioned electronic device; it may also exist separately and not be assembled into the electronic device.

The computer-readable medium carries one or more programs that, when the one or more programs are executed by the electronic device, enable the electronic device: extracting outline information of a first object in a template material, wherein the template material comprises the first object and a background; acquiring a recording material imported by a user based on the outline information, wherein the recording material comprises a second object corresponding to the first object; and adding the second object into a region corresponding to the first object in the template material to acquire a target video, wherein the target video comprises the second object and the background.

Computer program code for performing the operations of the present disclosure may be written in one or more programming languages, or combinations thereof, including object-oriented programming languages such as Java, Smalltalk, C++, conventional procedural programming languages such as the “C” language, or similar programming languages. or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer over any kind of network, including a LAN or WAN, or it may be connected to an external computer (e.g., via an Internet connection using an Internet service provider).

The flowcharts and block diagrams in the accompanying drawings illustrate the architecture, functionality, and operation of systems, methods, and computer program products that may be implemented in accordance with various embodiments of the present disclosure. At this point, respective box in the flowcharts or block diagrams may represent a module, program segment, or portion of code that contains one or more executable instructions for implementing a specified logical function. It should also be noted that in some implementations that are determined to be substitutions, the functions indicated in the boxes may also occur in a different order than that indicated in the accompanying drawings. For example, two consecutively represented boxes may actually be executed substantially in parallel, and they may sometimes be executed in reverse order, depending on the function involved. It should also be noted that respective of the boxes in the block diagrams and I or flowcharts, as well as combinations of the boxes in the block diagrams and I or flowcharts, may be implemented in a dedicated hardware-based system that performs the specified function or operation, or may be implemented in a combination of dedicated hardware and computer instructions.

Units described as being involved in embodiments of the present disclosure may be implemented by way of software or may be implemented by way of hardware. Wherein the name of a unit does not in some cases constitute a limitation of the unit itself, for example, a first acquiring unit may also be described as “a unit for acquiring at least two Internet Protocol addresses”.

The functions described above herein may be performed, at least in part, by one or more hardware logic components. For example, exemplary types of hardware logic components that may be used include: Field Programmable Gate Array (FPGA), Application Specific Integrated Circuit (ASIC), Application Specific Standard Parts (ASSP), System on Chip (SOC), and System on Chip (SOC). Application Specific Standard Parts (ASSP), System on Chip (System on Chip, SOC), Complex Programmable Logic Device (Complex Programmable logic device CPLD) and so on.

In the context of the present disclosure, a machine-readable medium may be a tangible medium that may include or store a program for use by or in conjunction with an instruction execution system, device, or apparatus. The machine-readable medium may be a machine-readable signal medium or a machine-readable storage medium. The machine-readable medium may comprise an electronic, magnetic, optical, electromagnetic, infrared, or semiconductor system, device, or apparatus, or any suitable combination thereof. Machine-readable storage media may comprise an electrical connection based on one or more wires, a portable computer disk, a hard disk, a random-access memory (RAM), a read-only memory (ROM), an erasable programmable read-only memory (EPROM or flash memory), a fiber optic, a compact disk-read-only memory (CD-ROM) for convenience, an optical storage device, a magnetic storage device, or any suitable combination of the foregoing. or any suitable combination thereof.

According to one or more embodiments of the present disclosure, Example 1 provides a method for video recording, comprising:
extracting outline information of a first object in a template material, wherein the template material comprises the first object and a background;
acquiring a recording material imported by a user based on the outline information, wherein the recording material comprises a second object corresponding to the first object; and
adding the second object into a region corresponding to the first object in the template material to acquire a target video, wherein the target video comprises the second object and the background.

Example 2 according to the method described in Example 1, acquiring a recording material imported by a user based on the outline information comprises:
generating an outline auxiliary line of the first object based on the outline information; and
displaying the outline auxiliary line in a user capturing interface, to guide the user to capture the recording material in accordance with the outline auxiliary line.

Example 3 according to the method described in Example 1, acquiring a recording material imported by a user based on the outline information comprises:
in the user capturing interface, in accordance with a determination that an error between an outline of the second object and the outline auxiliary line is within a setting range, determining a captured image as the recording material.

Example 4 according to the method described in Example 1, adding the second object into a region corresponding to the first object in the template material comprises:
removing the first object from the template material and adding the second object into the region corresponding to the first object in the template material.

Example 5 according to the method described in Example 1, further comprises:
performing, based on an image feature of the background, a background completion on a vacant region with the first object removed.

Example 6 according to the method described in Example 1, further comprises:
after acquiring a recording material imported by a user based on the outline information, further comprising: performing semantic partitioning or object partitioning on the recording material to acquire the second object.

Example 7 according to the method described in Example 1, further comprises:
adjusting a color of the second object based on image feature of the background.

Example 8 according to the method described in Example 1, further comprises:
calculating, based on the template material, a spherical harmonic lighting coefficient of the first object, and estimating a normal direction corresponding to the first object; and
performing light rendering on the second object based on the spherical harmonic lighting coefficient and the normal direction.

Example 9 according to the method described in Example 1, the content displayed by the user capturing interface further comprises the second object and a capturing background; or
the content displayed by the user capturing interface further comprises the second object and the background.

Example 10 according to the method described in Example 1, before extracting outline information of a first object in a template material, further comprises:
recognizing an object that support video recording in the template material; and
determining, based on user selection information, at least one first object from the recognized objects that supports video recording.

Example 11 according to the method described in Example 1, the number of the first objects is the same as the number of the second objects, and the number is at least two; and
adding the second object to a region corresponding to the first object in the template material comprises:
determining an association between at least two first objects and at least two second objects based on outline information of respective first objects in the template material and outline information of respective second objects in the recording material; and
adding respective second objects into regions corresponding to first objects associated with the respective second objects in the template material.

According to one or more embodiments of the present disclosure, Example 12 provides an apparatus of video recording, comprising:
an outline extraction module configured to extract outline information of a first object in a template material, wherein the template material comprises the first object and a background;
a material acquiring module configured to acquire a recording material imported by a user based on the outline information, wherein the recording material comprises a second object corresponding to the first object; and
a video recording module configured to add the second object into a region corresponding to the first object in the template material to acquire a target video, wherein the target video comprises the second object and the background.

According to one or more embodiments of the present disclosure, Example 13 provides an electronic device, comprising:
at least one processor; and
a storage apparatus configured to store at least one program;
wherein the at least one program, when executed by the at least one processor, causes the at least one processor to implement the method for video recording based on any of examples 1 to 11.

According to one or more embodiments of the present disclosure, Example 14 provides a computer-readable storage medium storing a computer program, the computer program, when executed by a processor, causing the method for video recording based on any of examples 1 to 11 to be implemented.

Furthermore, although a plurality of operations is depicted in a particular order, this should not be construed as requiring that the operations be performed in the particular order shown or in sequential order of performance. In certain environments, multitasking and parallel processing may be advantageous. Similarly, while a plurality of implementation details is included in the above discussion, these should not be construed as limiting the scope of the present disclosure. Some of the features described in the context of separate embodiments may also be implemented in combination in a single embodiment. Conversely, a plurality of features described in the context of a single embodiment may also be implemented in a plurality of embodiments, either individually or in any suitable sub-combination.

What is claimed is:

1. A method for video recording, comprising:
extracting outline information of a first object in a template material, wherein the template material comprises the first object and background;
acquiring a recording material imported by a user based on the outline information, wherein the recording material comprises a second object corresponding to the first object; and
adding the second object into a region corresponding to the first object in the template material to acquire a target video, wherein the target video comprises the second object and the background.

2. The method of claim 1, wherein acquiring a dueting recording material imported by a user based on the outline information comprises:
generating a profile auxiliary line of the first object based on the outline information; and
displaying the profile auxiliary line in a user capturing interface, to guide the user to capture the recording material in accordance with the profile auxiliary line.

3. The method of claim 2, wherein acquiring a recording material imported by a user based on the outline information comprises:
in the user capturing interface, in accordance with a determination that an error between a profile of the second object and the profile auxiliary line is within a setting range, determining a captured image as the recording material.

4. The method of claim 1, wherein adding the second object into a region corresponding to the first object in the template material comprises:
removing the first object from the template material and adding the second second object into the region corresponding to the first object in the template material.

5. The method of claim 4, further comprising:
performing, based on an image feature of the background, a background completion on a vacant region with the first object removed.

6. The method of claim 1, wherein after acquiring a recording material imported by a user based on the outline information, the method further comprises:
performing semantic partitioning or object partitioning on the recording material to acquire the second object.

7. The method of claim 1, further comprising:
adjusting a color of the second object based on image feature of the background.

8. The method of claim 1, further comprising:
calculating, based on the template material, a spherical harmonic lighting coefficient of the first object, and estimating a normal direction corresponding to the first object; and
performing light rendering on the second object based on the spherical harmonic lighting coefficient and the normal direction.

9. The method of claim 2, wherein the content displayed by the user capturing interface further comprises the second object and a capturing background; or
the content displayed by the user capturing interface further comprises the second object and the background.

10. The method of claim 1, further comprising: before extracting outline information of a first object in a template material,
recognizing an object that support video recording in the template material; and
determining, based on user selection information, at least one first object from the recognized objects that supports video recording.

11. The method of claim 1, wherein the number of the first objects is the same as the number of the second objects, and the number is at least two; and
adding the second object to a region corresponding to the first object in the template material comprises:
determining an association between at least two first objects and at least two second objects based on outline information of respective first objects in the template material and outline information of respective second objects in the recording material; and
adding respective second objects into regions corresponding to first objects associated with the respective second objects in the template material.

12-14. (canceled)

15. An electronic device, comprising:
at least one processor; and
a storage apparatus configured to store at least one program;
wherein the at least one program, when executed by the at least one processor, causes the at least one processor to implement the method for video recording comprising:
extracting outline information of a first object in a template material, wherein the template material comprises the first object and a background;
acquiring a recording material imported by a user based on the outline information, wherein the recording material comprises a second object corresponding to the first object; and
adding the second object into a region corresponding to the first object in the template material to acquire a target video, wherein the target video comprises the second object and the background.

16. The electronic device of claim 15, wherein acquiring a recording material imported by a user based on the outline information comprises:
generating an outline auxiliary line of the first object based on the outline information; and
displaying the outline auxiliary line in a user capturing interface, to guide the user to capture the recording material in accordance with the outline auxiliary line.

17. The electronic device of claim 16, wherein acquiring a recording material imported by a user based on the outline information comprises:
in the user capturing interface, in accordance with a determination that an error between an outline of the second object and the outline auxiliary line is within a setting range, determining a captured image as the recording material.

18. The electronic device of claim 15, wherein adding the second object into a region corresponding to the first object in the template material comprises:
removing the first object from the template material and adding the second object into the region corresponding to the first object in the template material.

19. The electronic device of claim 18, wherein the method further comprises:
performing, based on an image feature of the background, a background completion on a vacant region with the first object removed.

20. The electronic device of claim 15, wherein after acquiring a recording material imported by a user based on the outline information, the method further comprises:
performing semantic partitioning or object partitioning on the recording material to acquire the second object.

21. The electronic device of claim 15, wherein the method further comprises:
adjusting a color of the second object based on image feature of the background.

22. The electronic device of claim 15, wherein the method further comprises:
calculating, based on the template material, a spherical harmonic lighting coefficient of the first object, and estimating a normal direction corresponding to the first object; and
performing light rendering on the second object based on the spherical harmonic lighting coefficient and the normal direction.

23. A non-transitory computer-readable storage medium storing a computer program, the computer program, when executed by a processor, causing the method of for video recording comprising:
extracting outline information of a first object in a template material, wherein the template material comprises the first object and a background;
acquiring a recording material imported by a user based on the outline information, wherein the recording material comprises a second object corresponding to the first object; and
adding the second object into a region corresponding to the first object in the template material to acquire a target video, wherein the target video comprises the second object and the background.
